(19) United States
(12) Patent Application Publication
(10) Pub. No.: US 2017/0258679 A1
(43) Pub. Date: Sep. 14, 2017

(54) PEDICURE SPA

(71) Applicant: Spa Aid Ltd, Glendale, WI (US)

(72) Inventors: Yefim Drozdov, Glendale, WI (US); Yevgeny Drozdov, Glendale, WI (US)

(21) Appl. No.: 15/457,360

(22) Filed: Mar. 13, 2017

Related U.S. Application Data
(60) Provisional application No. 62/307,347, filed on Mar. 11, 2016.

(51) Int. Cl. A61H 35/00; A47C 1/06; A47C 7/54; A47K 3/022; A47C 1/11

(52) U.S. Cl. CPC A61H 35/006; A47K 3/022; A47C 1/11; A47C 7/54; A47C 1/06; A61H 2205/12; A61H 2203/0425

(57) ABSTRACT

A pedicure spa may include a basin and a lift mechanism that vertically moves the basin between a raised position in a lowered position while maintaining the basin in a single orientation. The pedicure spa may additionally include a chair, wherein the lift mechanism vertically moves the basin and the chair while maintaining the basin and the chair in a single orientation. The pedicure spa may linearly translate the chair relative to the basin while the basin and the chair are in a raised position. The pedicure spa may sense an obstruction below the basin and automatically interrupt lowering of the basin.

### CROSS-REFERENCE TO RELATED PATENT APPLICATIONS

The present application is a US non-provisional patent application claiming priority under 35 USC §119 from co-pending U.S. Provisional Patent Application Ser. No. 62/307,347 filed on Mar. 11, 2016 by Yefin Drozdov and entitled SPA APPARATUS, the full disclosure of which is hereby incorporated by reference.

### BACKGROUND

A pedicure is a cosmetic treatment of the feet and toenails. Persons receiving a pedicure are often seated upon a chair of a pedicure spa. Some pedicure spas include a basin in which a person's feet may soak.

### BRIEF DESCRIPTION OF THE DRAWINGS

FIG. 1 is a side view schematically illustrating an example pedicure spa with a basin in a raised position.

FIG. 2 is a side view of the example pedicure spa of Figure numeral one with the basin in a lowered position.

FIG. 3 is a side view schematically illustrating another example pedicure spa with a basin and a chair in a raised position.

FIG. 4 is a side view of the example pedicure spa of FIG. 3 with the basin and the chair in a lowered position.

FIG. 5 is a side view schematically illustrating another example pedicure spa with a chair in a rearward position while the chair and a basin are in a fully raised position.

FIG. 6 is a side view of the example pedicure spa of FIG. 5 with the chair in a forward position while the chair and the basin are in a fully raised position.

FIG. 7 is a side view schematically illustrating another example pedicure spa having a sensing system.

FIG. 8 is a top view schematically illustrating another example pedicure spa.

FIG. 9 is a side view schematically illustrating the pedicure spa of FIG. 8.

FIG. 10 is a side view of another example pedicure spa having a chair, a support and a basin in a raised position.

FIG. 11 is a front perspective view of the example pedicure spa of FIG. 10 with the chair, the support and the basin in a lowered position.

FIG. 12 is a front perspective view of a lift mechanism of the pedicure spa of FIG. 11 while the chair, the support and the basin are in the lowered position.

FIG. 13 is a front perspective view of the example pedicure spa of FIG. 10 with the chair, the support and the basin in the lowered position.

FIG. 14 is a front perspective view of the lift mechanism of the pedicure spa of FIG. 13 while the chair, the support and the basin are in the raised position.

FIG. 15 is another front perspective view of the lift mechanism of the pedicure spa of FIG. 14 omitting illustration of the basin.

FIG. 16 is an enlarged fragmentary bottom perspective view of an example carriage of the example pedicure spa of FIG. 10.

FIG. 17 is a front perspective view of the pedicure spa of FIG. 10 illustrating a top panel removed to illustrate an example sensing system.

FIG. 18 is a fragmentary rear perspective view of the sensing system of FIG. 17.

FIG. 19 is a fragmentary front perspective view of the sensing system of FIG. 17.

FIG. 20 is a partially exploded side view of a portion of the sensing system of FIG. 17.

FIG. 21 is a fragmentary side view of the pedicure spa of FIG. 17 with portions shown in section to illustrate the sensing system.

FIG. 22 is a fragmentary side view of the pedicure spa of FIG. 17 with portions shown in section to illustrate the sensing system as an obstruction is applying force to the sensing system.

### DETAILED DESCRIPTION OF EXAMPLES

Existing pedicure spas are often uncomfortable for the person receiving the pedicure or are uncomfortable for the technician providing the pedicure. Existing pedicure spas may also be overly complex, space consuming and expensive.

Disclosed herein are example pedicure spas that provide vertical height adjustment of a basin of the spa all while an orientation of the basin remains the same. In one implementation, the basin is maintained in a horizontal or level orientation as the basin is raised and lowered by lift mechanism. As a result, liquid within the basin is less like to spill and complex mechanisms to temporarily drain liquid from the basin to avoid such spillage may be omitted.

Disclosed herein are example pedicure spas that provide concurrent vertical height adjustment of both a chair and a basin of the spa all while an orientation of the chair and the basin remain the same. Disclosed herein are example pedicure spas that provide fore and aft adjustment, while in a raised state, all while an orientation of the chair and the basin remain the same. For example, the disclosed example pedicure spas allow both the chair and the basin to be raised and lowered while the chair in the basin remain in a substantially horizontal orientation. As a result, the liquid within the basin is less likely to spill due to tilting of the basin. In addition, the pedicure recipient's feet may be easily raised to a height that is more comfortable for the technician providing the pedicure.

Disclosed herein are example pedicure spas that provide concurrent vertical height adjustment of both the chair and a basin and that automatically interrupt the lowering upon sensing an obstruction or a person's anatomy below the chair in the basin being lowered. As a result, bulky and expensive shields may be reduced or eliminated to provide a sleek and aesthetically attractive pedicure spa.

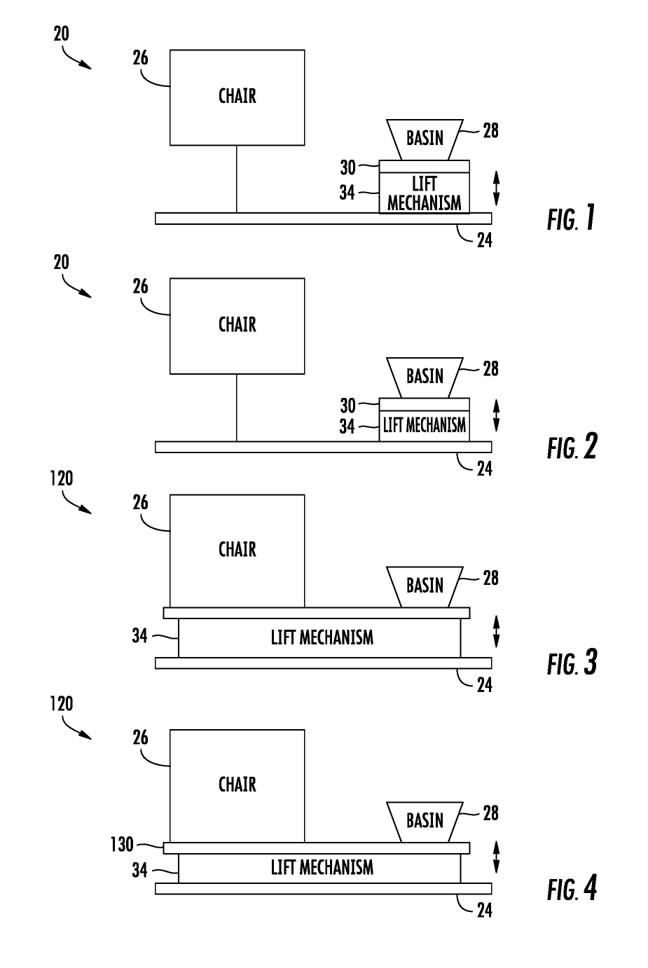

FIGS. 1 and 2 schematically illustrate an example pedicure spa 20. Pedicure spa 20 provides vertical height adjustment of a basin of the spa all while an orientation of the basin remains the same. In one implementation, the basin is maintained in a horizontal or level orientation as the basin is raised and lowered by lift mechanism. As a result, liquid within the basin is us like to spill and complex mechanisms to drain and add liquid to the basin to avoid such spillage may be omitted. Pedicure spa 20 comprises base 24, chair 26, basin 28, support 30 and lift mechanism 34.

Base 24 comprises comprise a foundation or platform structure for pedicure spa 20. In one implementation, base 24 comprise a framework having feet which rest upon the floor. In another implementation, base 24 may be altered or mounted to an underlying floor structure.

Chair 26 (schematically shown) comprise a structure upon which a person may be seated what his or her feet are placed within basin 28. Basin 28 comprises a tub or other similar structure configured to retain fluid, such as water, for various cleaning and massaging activities. In some implementations, basin 28 may contain foot rests and be connected to liquid jetting system.

Support 30 comprises a structure connected to at least basin 28 as well as lift mechanism 34. Support 30 is raised and lowered by lift mechanism 34. In one implementation, support 30 comprises a bracket. In other implementations, support 30 may have other configurations.

Lift mechanism 34 raises and lowers support 30 and basin 28 between a raised position (shown in FIG. 1) and a lowered position (shown in FIG. 2) while maintaining basin 28, containing liquid, in a level orientation. In one implementation, lift mechanism 34 may comprise a plurality of individual linear actuators that operate in unison to raise and lower support 30 and basin 28 in support 30 in a substantially level or a substantially, (+/−10°), horizontal orientation. For example, in one implementation, lift mechanism 34 may comprise a hydraulic or pneumatic cylinder assembly located in each corner of support 30 and under the control of controller to operate in unison to raise and lower basin 28 and support 30 while maintaining basin 28 and support 30 in a level or substantially horizontal orientation. In another implementation, lift mechanism 34 may comprise left and right or front and rear hydraulic or pneumatic cylinder assemblies that operate in unison to raise and lower basin 28 and support 30 while in a level or substantially horizontal orientation. In yet another implementation, as described in more detail below, lift mechanism 34 may comprise a four-bar linkage that raises and lowers support 30 and 28 between the raised position in a lowered position all while maintaining support 30 and basin 28 and a level or substantially horizontal orientation.

FIGS. 3 and 4 schematically illustrate pedicure spa 120, another example implementation of pedicure spa 20 described above. Pedicure spa 120 is similar to pedicure spa will 20 described above except that pedicure spa 120 comprises support 130 in lieu of support 30. The remaining components of spa 120 which correspond to components of spa 20 are numbered similarly.

Support 130 is similar to support 30 except that support 130 additionally supports and extends below chair 26. As a result, the raising and lowering of support 130 by lift mechanism 34 concurrently and synchronously raises and lowers both chair 26 and basin 28 between a raised position and a lowered position all while maintaining both chair 26 and basin 28 in a single level or a single substantially horizontal orientation. In other words, neither chair 26 nor basin 28 pivot about a horizontal axis forwardly or rearwardly as chair 26 and basin 28 are raised or lowered. For purposes of this disclosure, with respect to an orientation, a “substantially” horizontal orientation is an orientation that is parallel to the horizon with a tolerance of +/−10 degrees.

Support 130 comprises a structure connected to at least basin 28 as well as lift mechanism 34. Support 130 is raised and lowered by lift mechanism 34. In one implementation, support 130 comprises a bracket. In other implementations, support 130 may have other configurations.

As with spa 20, in spa 120, lift mechanism 34 raises and lowers support 130, chair 26 and basin 28 between a raised position (shown in FIG. 3) and a lowered position (shown in FIG. 4) while maintaining basin 28, containing liquid, and the chair upon which the person receiving the pedicure rests, in a level orientation. In one implementation, lift mechanism 34 may comprise a plurality of individual linear actuators that operate in unison to raise and lower support 130, chair 26 and basin 28 while they are being maintained in a substantially level or a substantially, (+/−10°), horizontal orientation. For example, in one implementation, lift mechanism 34 may comprise a hydraulic or pneumatic cylinder assembly located in each corner of support 130 and under the control of controller so as to operate in unison to raise and lower chair 26, basin 28 and support 130 while maintaining chair 26, basin 28 and support 130 in a level or substantially horizontal orientation. In another implementation, lift mechanism 34 may comprise left and right or front and rear hydraulic or pneumatic cylinder assemblies that operate in unison to raise and lower basin 28 and support 130 while in a level or substantially horizontal orientation. In yet another implementation, as described in more detail below, lift mechanism 34 may comprise a four-bar linkage that raises and lowers support 130, chair 26 and basin 28 between the raised position and the lowered position all while maintaining support 130, chair 26 and basin 28 and a level or substantially horizontal orientation.

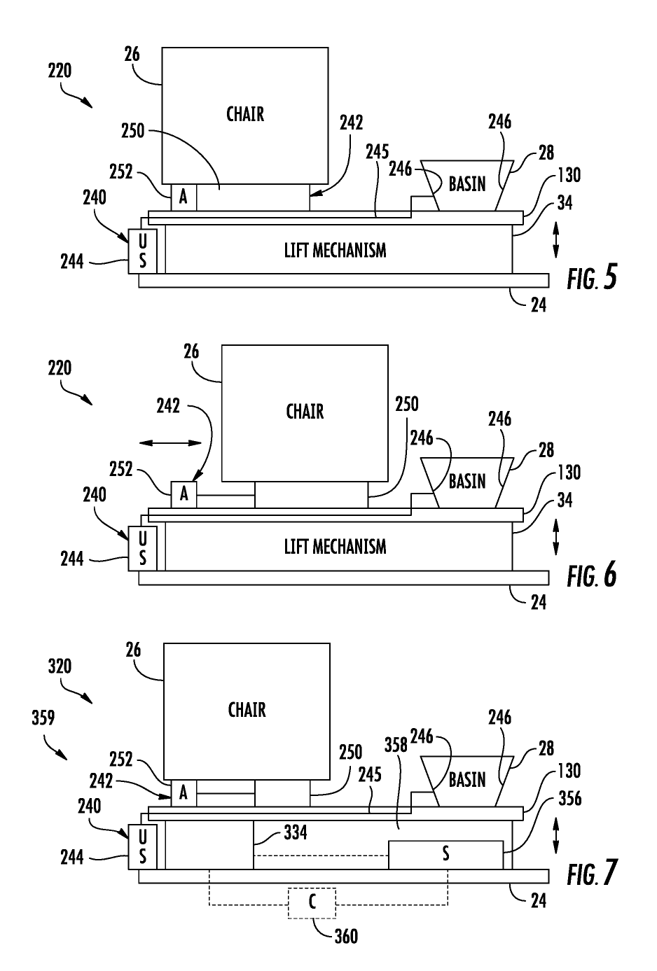

FIGS. 5 and 6 schematically illustrate pedicure spa 220, another example implementation of pedicure spa 20. Pedicure spa 220 is similar to pedicure spa 120 described above except that pedicure spa 220 additionally comprises liquid jetting system 240 and carriage 242. Those remaining components of spa 220 which correspond to components of spas 20 or 120 are numbered similarly.

Liquid jetting system 240 (schematically shown) comprises is to direct a stream of fluid or liquid asset about the person's feet within basin 28. In one implementation of liquid jetting system 240, liquid jetting system 240 comprise a manifold or screen about an impeller to drive liquid through a nozzle opening to direct a stream of fluid toward the person's feet, such as at the person's toes. In one implementation liquid jetting system 240 comprises a pump 244 plumbed by flexible conduits or hoses 245 that are fluidly coupled to nozzles 246 within basin 28. The number and location of such nozzles may be varied and may be selectively actuated to accommodate different preferences.

Carriage 242 comprises a mechanism to linearly translate chair 26 forwardly or rearwardly relative to basin 28. Carriage 242 linearly translates chair 26 along support 130 while supporting and translating chair 26 relative to basin 28 between a rearward position (shown in FIG. 5) in a forward position (shown in FIG. 6) while chair 26 is in the raised position and while chair 26 and basin 28 are both maintained in a single level or substantially horizontal orientation. In the example illustrated, carriage 242 linearly translates chair 26 forwardly and rearwardly relative to basin 28 while chair 26 is in both the raised position and the lowered position and while chair 26 and basin 28 are both maintained in a single level or substantially horizontal orientation.

In one implementation, carriage 242 comprises a guide 250 and an actuator 252. Guide 250 comprises a track, rail, rod or other mechanisms which guide linear forward and rearward movement of chair 26. Actuator 252 comprises a mechanism which applies force to chair 26 to move chair 26 relative to support 130, as guided by guide 250. In one implementation, actuator 252 may comprise a hydraulic or pneumatic cylinder assembly pivotally pinned at one end to support 130 and pivotally pinned at another end to chair 26. In yet another implementation, actuator 252 may comprise an electric solenoid, a rack and pinion gear arrangement driven by a motor or other powered mechanisms. In yet other implementations, actuator 252 may be omitted, wherein chair 26 is manually move rearwardly or forwardly relative to support 130 and relative to basin 28 and wherein chair 26 may be selectively latched, locked, pinned or otherwise retained in one of a plurality of available forward and rearward positions.

FIG. 7 schematically illustrates pedicure spa 320, another example implementation of pedicure spa 20. Pedicure spa 320 is similar to pedicure spa 220 described above except that pedicure spa 320 comprises lift mechanism 334 in place of lift mechanism 34 and additionally comprises sensor 356. Those remaining components of spa 320 which correspond to components of spas 20, 120 and 220 are numbered similarly.

Lift mechanism 334 is similar to lift mechanism 34 described above except that lift mechanism 334 cantilevers or otherwise supports support 130 above base 24 so as to form a gap 358 beneath support 130 between support 130 and base 24. In the example illustrated, gap 358 is directly beneath basin 28 and is directly beneath those portions of support 130 that extend between chair 26 and basin 28. In one implementation, lift mechanism 334 may comprise a four-bar linkage at the rear 359 of spa 320 and at the rear 359 of support 130. In another implementation, lift mechanism 334 may not necessarily cantilever support 130, but elevate support 130 at one or more locations, such as along the sides or front of support 130, so as to create a gap 358 underlying basin 28 and/or other portions of support 130.

Sensor 356 comprise a sensing device that is located and/or configured to sense an obstruction within gap 358, such as an obstruction below support 130 and/or below basin 28. Examples of such an obstruction may be another object or article or may be a person's anatomy, such as a person's foot. In response to such an obstruction occupying gap 358, sensor 358 outputs signals indicating the presence of such an obstruction, wherein the lowering of support 130 by lift mechanism 34 is automatically interrupted or inhibited in response to or based upon such signals.

In one implementation, sensor 356 comprises force or pressure sensor which outputs such signals indicating the presence of an obstruction in response to a force or weight the exerted upon elements of sensor 356 In another implementation, sensor 356 comprises an optical sensor, such as one or more photo emitter-detector pairs which direct a beam or beams of light within gap 358. In yet other implementations, sensor 356 may comprise other types of sensors.

In one implementation, sensor 356 may comprise at least one post project upwards from base 24 towards support 130 while underlying and supporting a panel overlying and movably supported by the at least one post. The at least one post is movable between an extended position and a retracted position. At least one post is really biased to the extended position. The at least one post moves towards a retracted position in response to force upon the panel, wherein lowering of the support 130 by a linear actuator by lift mechanism 334 is automatically interrupted or prevented in response to the at least one post being moved to the retracted position.

In one implementation, sensor 256 comprises a pressure switch that automatically breaks an electrical circuit connected to lift mechanism 334 such that powers no longer delivered to lift mechanism 334 and ongoing lowering is interrupted or the initiation of lowering of support 130 by lift mechanism 334 is interrupted. In another implementation, signals from sensor 356 or output to a controller 360 (shown in broken lines) which outputs control signals interrupting the operation of lift mechanism 334, either interrupting ongoing lowering of support 130 or preventing the initiation of the lowering of support 130 by lift mechanism 334. In such an implementation, controller 360 may comprise actuation logic, such as a microcontroller, integrated circuit, application-specific integrated circuit or microprocessor that follows instructions contained in a non-transitory computer-readable medium.

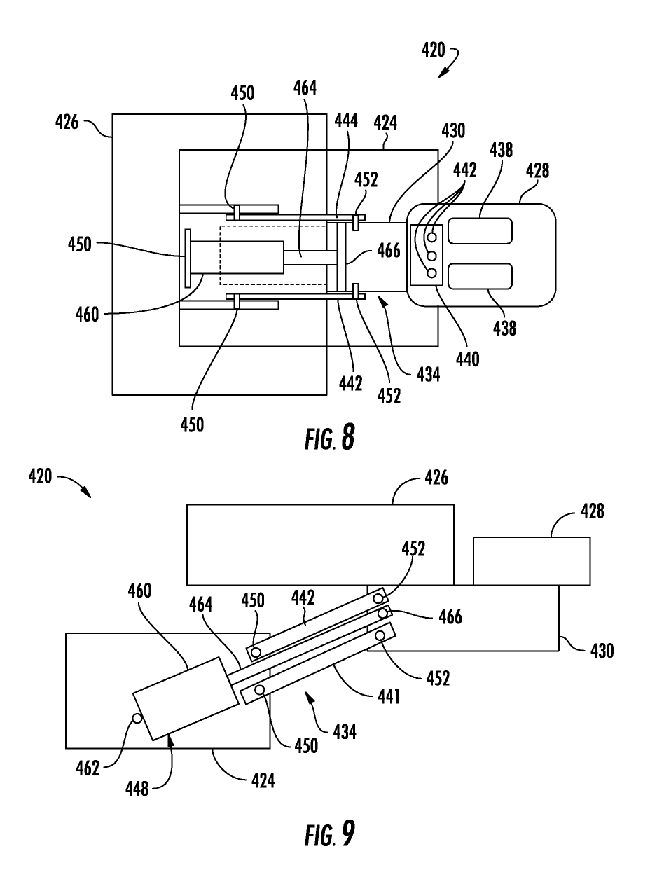

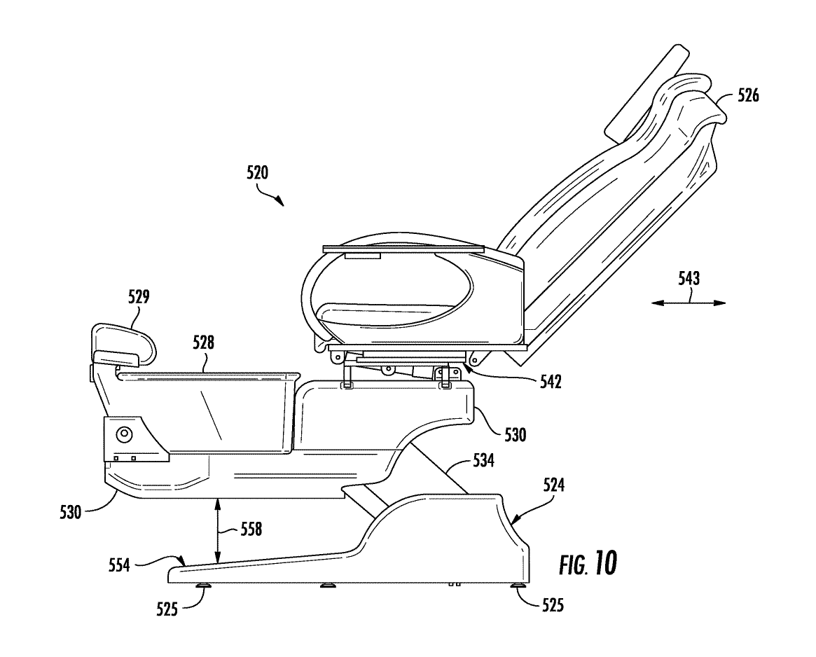

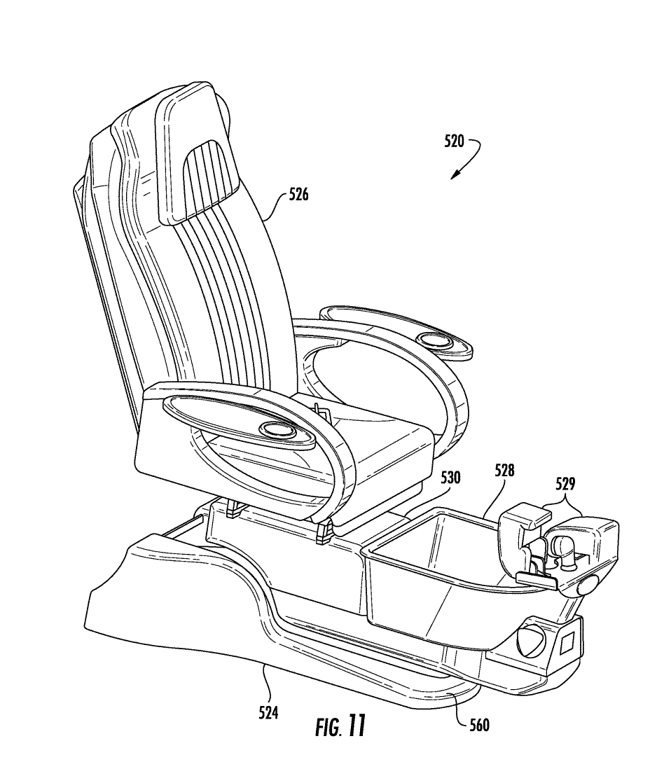

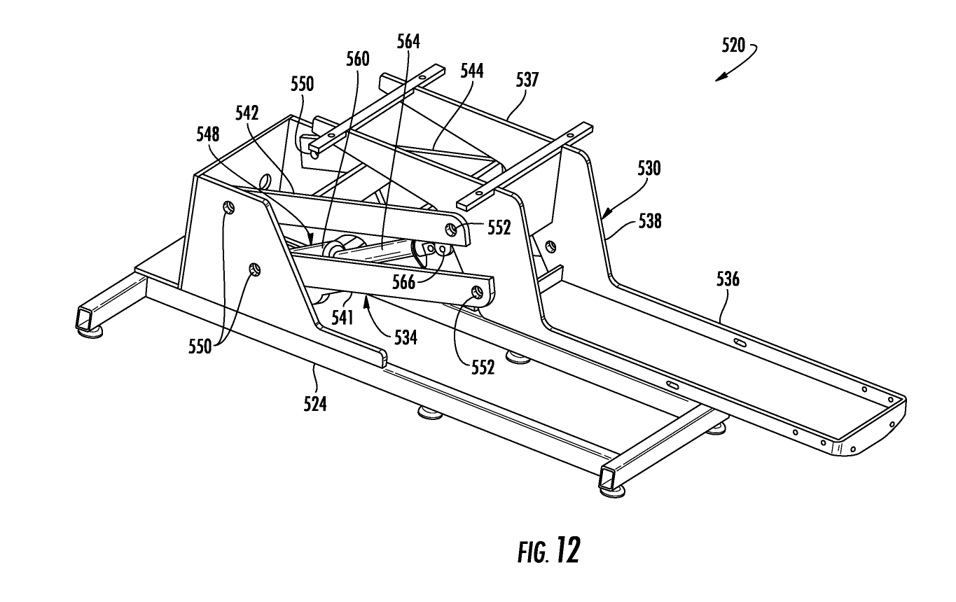

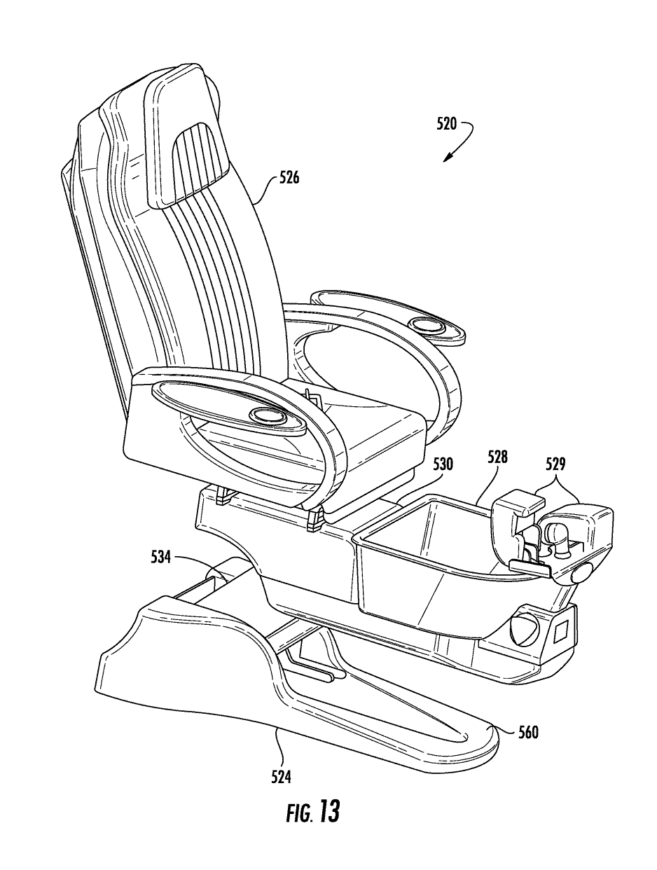

FIGS. 8 and 9 schematically illustrate an example pedicure spa 420. Pedicure spa 420 is configured for use in providing foot massages, pedicures and other activities related to the feet, including bathing, soaking and stimulating such feet. As will be described hereafter, pedicure spa 420 utilizes a lift mechanism that allows a chair and basin of the football to be simultaneously raised and lowered while being maintained at the same horizontal angle such that fluid contained within the football basin do not spill and are maintained level. Pedicure spa 420 (also referred to as a foot spa) comprises base 424, chair 426, basin 428, support 430 and lift mechanism 434.

Base 424 comprises comprise a foundation or platform structure for foot spa 420. In one implementation, base 424 comprise a framework having feet which rest upon the floor. In another implementation, base 424 may be altered or mounted to an underlying floor structure.

Chair 426 (schematically shown) comprise a structure upon which a person may be seated what his or her feet are placed within basin 428. Basin 428 comprises a tub or other similar structure configured to retain fluid, such as water, for various cleaning and massaging activities. As schematically shown by FIG. 1, basin 428 contains foot rests 438 and liquid jetting system 440.

Foot rests 438 comprise structures raised above the floor of basin 428 for supporting the person's feet above the floor of basin 428. In one implementation, foot rests 438 are fixed within basin 428. In one implementation of foot rest 438 are adjustably positioned by being slid forward or rearward or tilted to accommodate different anatomies of a person seated in chair 426. Foot rest 438 may protect the foot from contact from rotating impeller housing beneath the foot rest 438. Foot rests 438 may additionally confine or constrict the flow of liquid from the impeller to liquid jetting system 440.

Liquid jetting system 440 (schematically shown) comprises a system to direct a stream of fluid or liquid at and about the person's feet resting upon foot rests 438. In one implementation of liquid jetting system 440 comprises a manifold or screen about an impeller which drives liquid through nozzle openings 442 to direct a stream of fluid towards the person's feet front of feet, including the person's toes. In some implementations, such nozzles 442 may direct fluid in a non-vertical direction, such as at the back of the foot or the person's heal.

Support 430 comprises a structure connected to chair 426 and basin 428 as well as lift mechanism 434. Support 430 is raised and lowered by lift mechanism 434. In one implementation, support 430 comprises a bracket. In other implementations, support 430 may have other configurations. In some implementations, chair 426 may be supported independent of basin 428, wherein lift mechanism 434 raises and lowers basin 428, while in a level orientation, independent of chair 426.

Lift mechanism 434 raises and lowers support 430, chair 426 and basin 428 while maintaining basin 428, containing liquid, in a level orientation. Lift mechanism 434 comprises two pairs of linkages, a first pair of linkages on the right side, linkages 441, 442, and a second pair of linkages on the left side, linkages 444 and an underlying linkage corresponding to linkage 440 on the left side and a linear actuator 448. Linkages 441, 442 each have a first end 450 pivotably connected to base 424 and a second opposite end pivotably connected to support 430. In one implementation, such and are pivotably connected via pins. Similarly, each of the linkages on the left side, linkages 444 and the underlying linkage also have a first end pivotally connected to base 424 and a second opposite end pivotably connected to support 430. The pivotal connections are spaced apart from one another such that the vertical extent of base 424 between the pivotal ends of linkages 440, 442, the vertically extending portion of support 430 extending between the pivotal ends of linkages 440, 442, linkage 440 and linkage 442 form a four-bar linkage. The two linkages on the left side form a similar four-bar linkage.

Linear actuator 448 comprises a mechanism that may be selectively extended and retracted response to control signals from a controller. In the example illustrated, linear actuator 448 comprises a double acting cylinder-piston assembly or actuator, wherein one of the cylinder and the piston is pivotally connected to base 424 and wherein the other of the cylinder and piston is pivotably connected to support 430. In another implementation, linear actuator 48 may comprise a pair of single acting cylinder-piston assemblies, one for each direction. In the example illustrated, the cylinder 460 of the assembly is pivotably connected to base 424 at a pivot pin 462 while the piston 464 is pivotably connected to support 430 at a pivot pin 466. In one implementation, the cylinder piston assembly comprises a pneumatic cylinder-piston assembly (sometimes known as an air cylinder). In another implementation, cylinder piston assembly comprises a hydraulic cylinder-piston assembly (sometimes known as a hydraulic cylinder). In yet other implementations, linear actuator 448 may comprise an electric solenoid having a rod that is selectively extendable and retractable with respect to a cylinder. In yet other implementations, other linear actuators may be employed, wherein one end of the linear actuator is pivotally connected to base 424 and the other end of the linear actuator is pivotally connected to support 430.

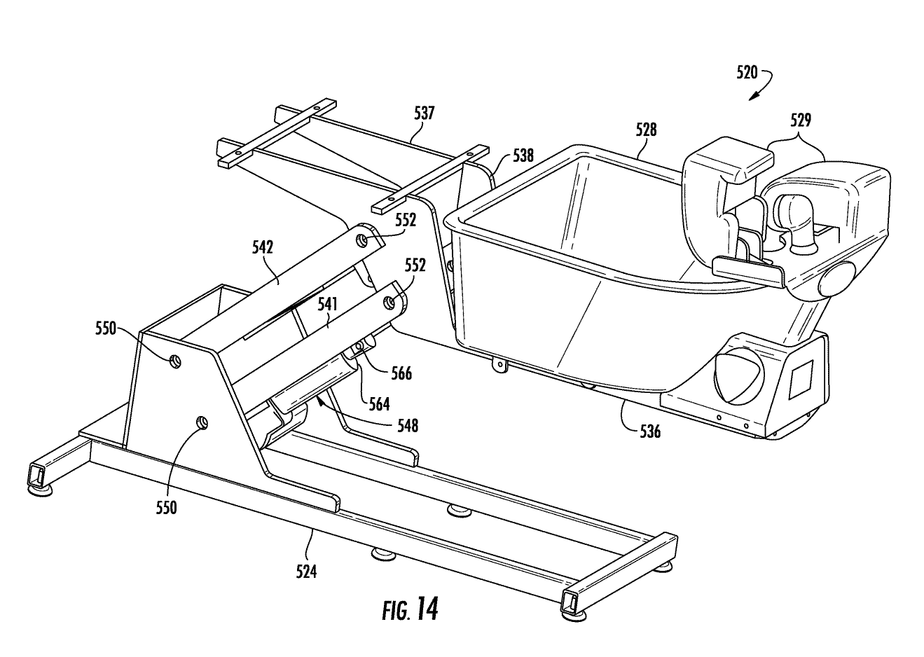

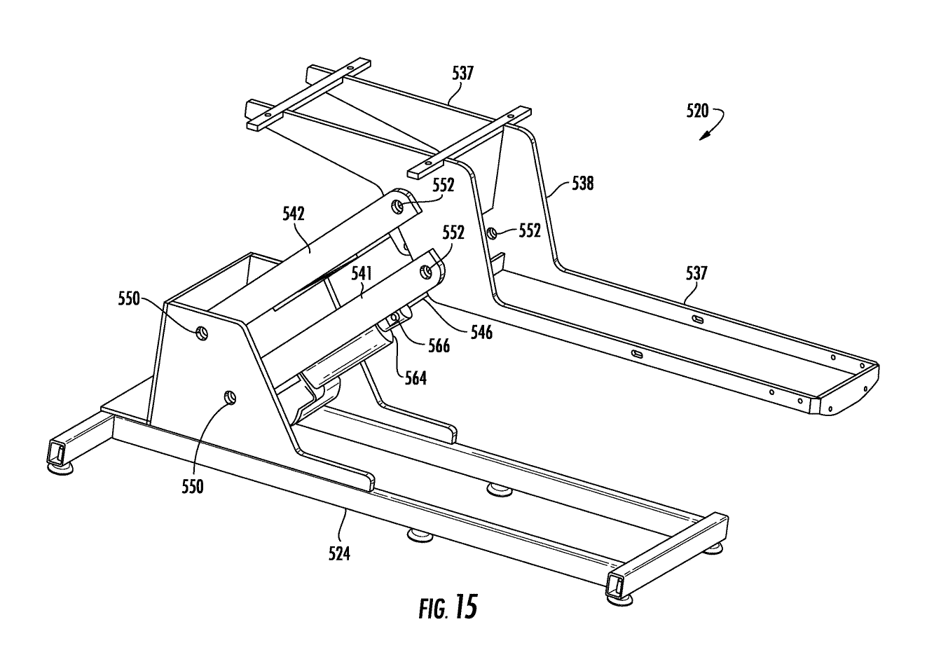

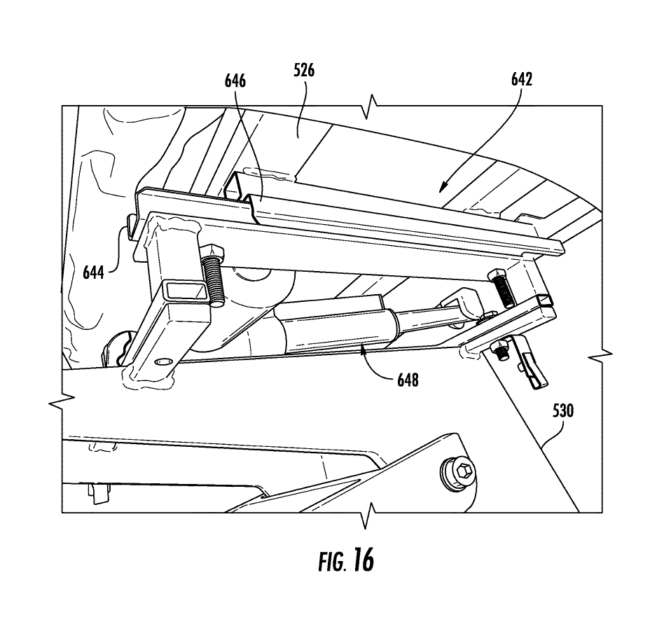

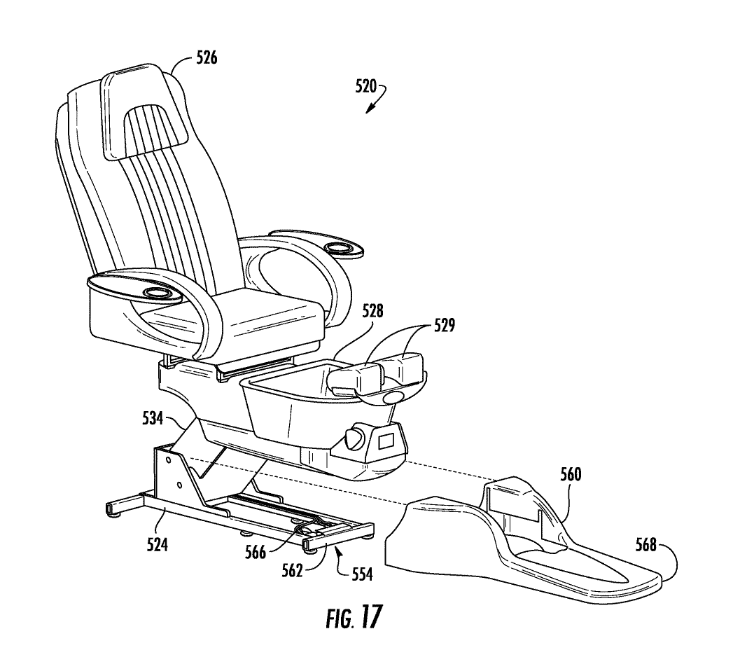

FIGS. 10-22 illustrate pedicure spa 520, a particular implementation of pedicure spa 420. Pedicure spa 520 comprises base 524, chair 526, basin 528, adjustable foot rests 529, support 530, lift mechanism 534, carriage 642 and sensing system 654. Base 524 comprises a foundation or platform structure for pedicure spa 520. In one implementation, base 524 comprise a framework having feet 525 which rest upon the floor. In another implementation, base 524 may be altered or mounted to an underlying floor structure.

Chair 526 comprise a structure upon which a person may be seated what his or her feet are placed within basin 528. Basin 528 comprises a tub or other similar structure configured to retain fluid, such as water, for various cleaning and massaging activities. Basin 528 contains foot rests 38 and liquid jetting system 240, shown and described above with respect to spas 220 and 420.

Support 530 comprises a structure connected to chair 526 and basin 528 as well as lift mechanism 534. FIGS. 12, 14 and 15 illustrate support 530 in more detail. In the example illustrated, support 530 comprises a lower support bracket 536, an upper support bracket 537 and an intermediate bracket 538. Lower support bracket 536 underlies basin 528 while upper support bracket 537 underlies chair 526 (shown in FIGS. 10, 11 and 13). Support 530 is raised and lowered by lift mechanism 534. Intermediate bracket 538 is pivotally connected to lift mechanism 534. In other implementations, support 530 may have other configurations. In some implementations, chair 526 may be supported independent of basin 528, wherein lift mechanism 534 raises and lowers basin 528, while in a level orientation, independent of chair 526.

FIGS. 12, 14 and 15 illustrate lift mechanism 534 in more detail omitting other components of spa 520 for ease of illustration. As with lift mechanisms 34, 434 described above, lift mechanism 534 vertically raises and lowers support 530, chair 526 and basin 528 concurrently between a raised position shown in FIGS. 10 and 13 and a lowered position shown in FIG. 11. The raising and lowering of chair 526 and basin 528 is achieved while chair 526 and basin 528 are maintained in a single level or substantially horizontal orientation.

Lift mechanism 534 is similar to lift mechanism 434 described above. In a similar fashion, lift mechanism 534 raises and lowers support 530, chair 526 and basin 528 while maintaining basin 528, containing liquid, in a level orientation. Lift mechanism 534 comprises two pairs of linkages, a first pair of linkages on the right side, linkages 541, 142, and a second pair of linkages on the left side, linkages 544,546 and a linear actuator 548. Linkages 541, 542 each have a first end 550 pivotably connected to upstanding plates of base 524 and a second opposite end 552 pivotably connected to support 530. In one implementation, such ends 550, 552 are pivotably connected via pins. Similarly, each of the linkages on the left side, linkages 544 and the underlying linkage also have a first end pivotally connected to base 524 and a second opposite end pivotably connected to support 530. The pivotal connections are spaced apart from one another such that the vertical extent of base 524 between the pivotal ends of linkages 541, 542, the vertically extending portion of support 530 extending between the pivotal ends of linkages 541, 542, linkage 541 and linkage 542 form a four-bar linkage. The two linkages on the left side form a similar four-bar linkage.

Linear actuator 548 comprises a mechanism that may be selectively extended and retracted response to control signals from a controller. In the example illustrated, linear actuator 548 comprises a double acting cylinder-piston assembly or actuator, wherein one of the cylinder and the piston is pivotally connected to base 524 and wherein the other of the cylinder and piston is pivotably connected to support 530. In another implementation, linear actuator 548 may comprise a pair of single acting cylinder-piston assemblies, one for each direction. In the example illustrated, the cylinder 560 of the assembly is pivotably connected to base 524 at a pivot pin while the piston 564 is pivotably connected to support 530 at a pivot pin 566. In one implementation, the cylinder piston assembly comprises a pneumatic cylinder-piston assembly (sometimes known as an air cylinder). In another implementation, cylinder piston assembly comprises a hydraulic cylinder-piston assembly (sometimes known as a hydraulic cylinder). In yet other implementations, linear actuator 548 may comprise an electric solenoid having a rod that is selectively extendable and retractable with respect to a cylinder. In yet other implementations, other linear actuators may be employed, wherein one end of the linear actuator is pivotally connected to base 524 and the other end of the linear actuator is pivotally connected to support 530.

Carriage 642 is similar to carriage 242 described above in that carriage 542 linearly translates the overlying chair 526 towards and away from basin 528, relative to basin 528, in the direction indicated by arrows 543 (shown in FIG. 10. As with carriage 242, carriage 642 linearly translates chair 526 fore and aft relative to basin 528 while chair 526 and basin 528 or in the fully raised position (the highest elevation at which chair 526 and basin 528 may be supported). During such linear translation, chair 526 and basin 528 are maintained in a level or substantially horizontal orientation. As a result, the person receiving the pedicure is not further tilted or reoriented and the liquid within basin 528 is less likely to spill.

FIG. 16 illustrates a close-up view of carriage 642. As shown by FIG. 16, carriage 642 comprises track 644, rider 646 and actuator 648. Track 642 comprise a structure fixed to support 530 which guides fore and aft movement of rider 646. In the example illustrated, track 644 comprises an elongate bar having a U-shaped channel with outwardly extending flanges. In other implementations, track 644 may have other configurations.

Rider 646 comprises a structure fixed to an underside of chair 526 and that is movably supported along track 644 for fore and aft movement along track 644. In the example illustrated, rider 646 comprises an elongate bar having a downward facing U-shaped channel with inwardly extending portions that are captured below the outwardly extending flanges of track 644. In one implementation, rider 646 rests upon and bears against low friction surfaces. In another implementation, one or more bearings are provided between track 644 and rider 646 to facilitate sliding relative movement. In other implementations, track 644 and rider 646 may have other configurations that facilitate guided forward and rearward movement of chair 526 relative to support 530.

Actuator 648 comprise a powered mechanism that moves rider 646 and chair 526 along track 644 in response to commands received from a controller which may be in communication with a remote control or other user input device. In the example illustrated, actuator 648 comprises a double-acting pneumatic cylinder having one end pivotally coupled to support 530 and another end pivotally coupled to a bottom of chair 526, wherein actuator 648 is selectively extendable and retractable in both directions. In yet other implementations, actuator 648 may comprise a pair of single acting hydraulic or pneumatic cylinder-piston assemblies. In still other implementations, actuator 648 may comprise other linear actuators. For example, in another implementation, linear actuator 648 may comprise a rack gear secured to chair 526 and a pinion gear meshing with the rack gear and supported by support 530, wherein a bidirectional motor selectively rotates the pinion gear to selectively drive chair 526 either forwardly or rearwardly. In yet other implementations, actuator 648 may be omitted, wherein chair 526 is manually pushed forwardly or rearwardly and wherein separate latches, clips or other mechanisms are used to releasably retain chair 526 in a desired fore-aft position.

As shown in FIG. 10, lift mechanism 534 cantilevers support 530 and basin 528 above base 524, forming a gap 558 therebetween. In one implementation, gap 558 has a gap size of at least 3 inches and nominally at least 5 inches. Gap 558 produces a material and weight of pedicure spa 520 providing pedicure spa 520 with a sleek aerodynamic appearance.

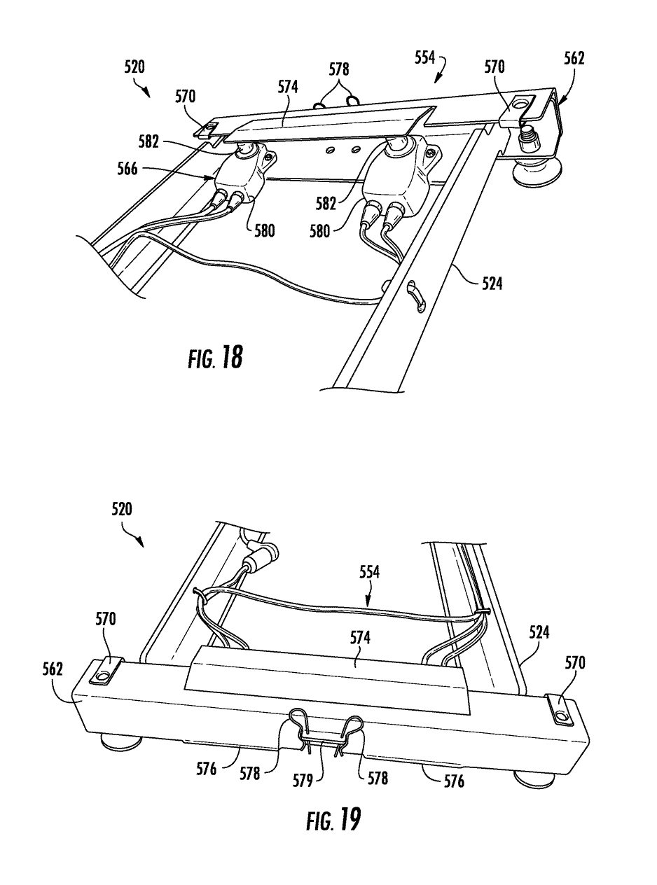

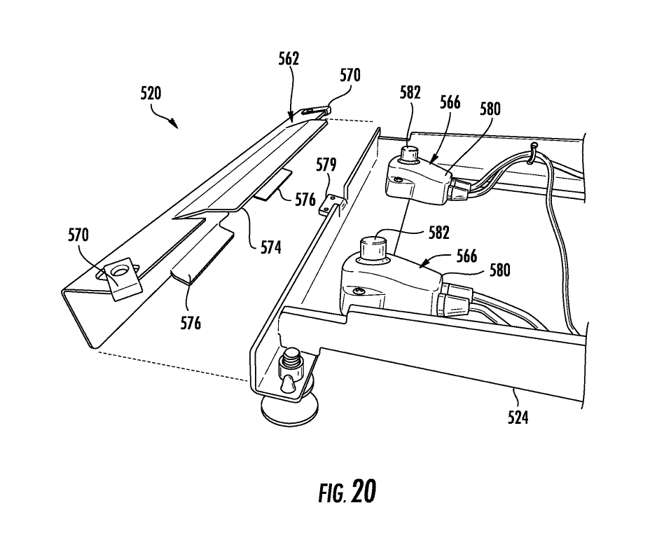

Sensing system 554 detects the presence an obstruction within gap 558, such as an obstruction below support 50 and/or below basin 528. Examples of such an obstruction may be another object or article or may be a person's anatomy, such as a person's foot. FIGS. 17-22 illustrate sensing system 554 in more detail. Sensing system 554 comprises top panel 560 (shown in FIG. 17), forced coupling bar 562, and sensor 566 (shown in FIGS. 18-20).

Top panel 560 overlies bar 552 and sensor 566. Top panel 560 extends directly adjacent to gap 558. In the example illustrated, top panel 560 is wider than support 530 and projects forward of base 524, serving as a shield for such structures. In the example illustrated, top panel 560 is secured to base 524 proximate a rear of spa 520, whereas a front end 568 of top panel 560 floats. In other words, the front end 568 of top panel 560 is vertically movable up and down in response to receiving a downwardly directed force from within gap 558. In the example illustrated, top panel 560 is formed from a polymer or resiliently flexible material, facilitating downward resilient flexing of panel 560 in response to receiving a downward force from within gap 558. In other implementations, rear of top panel 560 may be pivotally supported or may be vertically supported by other structures such as springs.

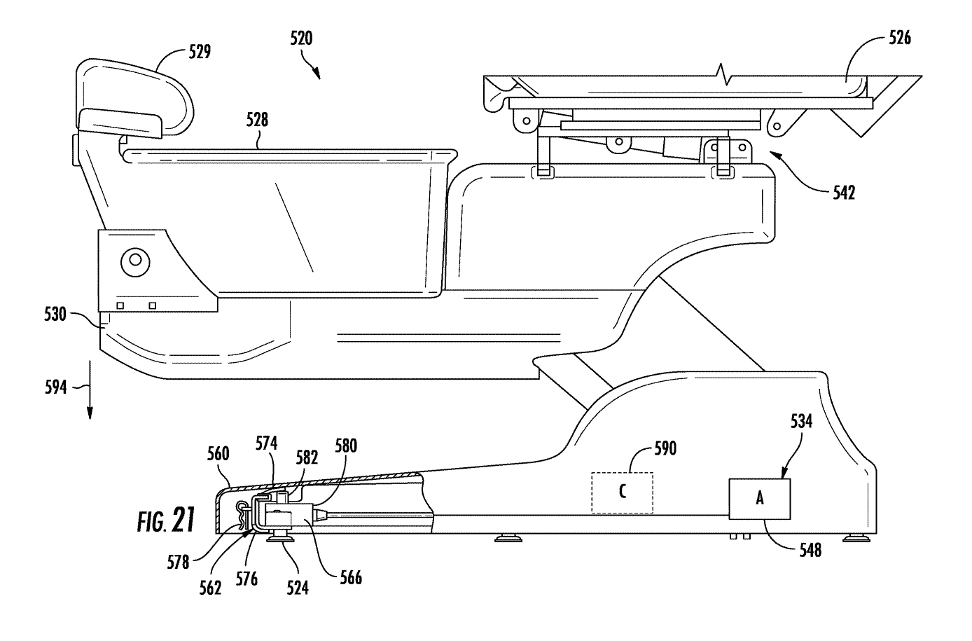

Forced coupling bar 562 is secured to top panel 560 and extend between top panel 560 and sensors 566. As shown by FIG. 20, forced coupling bar 562 comprise a pair of clips 570 which are clipped to top panel 560. As a result, forced coupling bar 562 vertically move in unison with the front 568 of top panel 560.

As further shown by FIG. 20, forced coupling bar 562 further comprises sensor contacting portion 574, vertical limit tabs 576 and retainers 578 (shown in FIG. 19). Sensor contacting portion 574 projects over sensors 566 and is supported in a floating manner by sensors 566. Vertical limit tabs 576 project below a front end of base 524 to limit vertical lifting of bar 562 and of top panel 560. Retainers 578 (shown in FIG. 19) inhibit forward movement of bar 562 and top panel 560. In the example illustrated, retainers 578 comprise clips that are secured to a projecting portion 579 of base 524 projecting through or beneath bar 562. In other implementations, retainers 578 may have other configurations or may be omitted. Likewise, in some implementations, vertical limit tabs 576 may be omitted.

Sensor 566 comprises a sensing device underlying top panel 560 so as to sense or output signals indicating downward movement of top panel 560 which may result from an obstruction within gap 558. In the example illustrated, sensor 566 comprises a pair of transversely spaced force or pressure sensors 580. In one implementation, each of the individual pressure sensors 580 comprises a post 582 that projects upwardly below sensor contacting portion 574. Each post 582 is movable between an extended position and a retracted position. Each post 582 is biased to the extended position. Each post 582 moves towards a retracted position in response to a downward force upon the top panel 560 are transmitted to such posts 582 by force coupling bar 562.

In other implementations, sensor 556 may have other configurations. For example, in other implementations, sensors 566 may output signals, not in response to posts 582 being depressed, but in response to mere contact with bar 562. In such an implementation, bar 562 may be resiliently supported at a predetermined distance above such contact sensors, bar 562 or mechanisms carried by bar 562 are brought into contact with sensors 566 upon sufficient downward movement of top panel 560. Although sensor 566 are illustrated as underlying top panel 560 and bar 562, wherein top panel 560 and bar 562 are lowered into interaction with sensors 566, in other implementations, sensors 566 may alternatively face in a downward direction and be carried by top panel 560 and/or forced coupling bar 562, wherein such sensors 566 are lowered into contact with portions of base 524 to trigger the output of signals indicating an obstruction above top panel 560.

In yet other implementations, sensors 566 may comprise other types of sensors. For example, in another implementation, sensor 556 may comprise an optical sensor, such as one or more photo emitter-detector pairs which direct a beam or beams of light within gap 558.

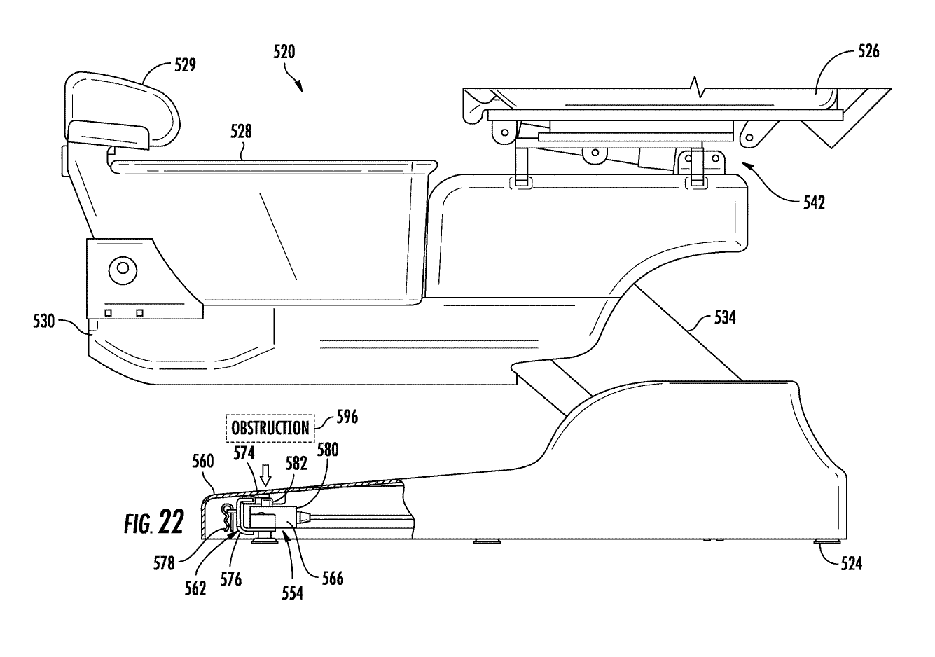

In one implementation, each of sensors 580 comprises a pressure switch that automatically breaks an electrical circuit connected to lift mechanism 534 such that powers no longer delivered to lift mechanism 534 and ongoing lowering is interrupted or the initiation of lowering of support 530 by lift mechanism 534 is interrupted. In another implementation, signals from sensor 566 are output to a controller 590 (shown in broken lines in FIG. 21) which outputs control signals interrupting the operation of actuator 548 of lift mechanism 534, either interrupting ongoing lowering of support 530 or preventing the initiation of the lowering of support 530 by lift mechanism 534. In such an implementation, controller 590 may comprise actuation logic, such as a microcontroller, integrated circuit, application-specific integrated circuit or microprocessor that follows instructions contained in a non-transitory computer-readable medium.

FIGS. 21 and 22 illustrate the operation of sensing system 554. FIG. 21 illustrates lift mechanism 534 about to lower support 530, chair 526 and basin 528 or during the lowering support 530, chair 526 and basin 528 as indicated by arrow 594. FIG. 22 illustrates a presents an obstruction 596 (schematically shown) exerting a downward force upon top panel 560. This downward force is transmitted by force coupling bar 562 to posts 582 of the individual pressure sensors 580 of sensor 566. As a result, signals are output which either automatically interrupt or discontinue the supply of power to actuator 548 (shown in FIG. 21), as when sensor 566 comprise a pressure switch, or result in controller 590 automatically outputting control signals that automatically interrupt or any prevent the initiation of the lowering of support 530, chair 526 and basin

Although the present disclosure has been described with reference to example implementations, workers skilled in the art will recognize that changes may be made in form and detail without departing from the spirit and scope of the claimed subject matter. For example, although different example implementations may have been described as including one or more features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A pedicure spa comprising:
a base;
a chair;
a basin;
a support supporting the basin; and
a lift mechanism to vertically move the support and the basin between a raised position and a lowered position while the support and the basin remain in a single orientation.

2. The pedicure spa of claim 1, wherein the support supports the chair with the basin and wherein the lift mechanism is to vertically move the support, the chair and the basin between the raised position and the lowered position while the support, the chair and the basin remain in the single orientation.

3. The pedicure spa of claim 2, wherein the lift mechanism comprises:
a first linkage having a first end pivotably connected to the base and a second end pivotably coupled to the support;
a second linkage having a first end pivotably connected to the base and a second and pivotably coupled to the support; and
a linear actuator having a first end pivotally connected to the base and a second and pivotably coupled to the support, wherein the first linkage, second language and the linear actuator form a four-bar linkage to concurrently raise and lower the chair and the basin while maintaining the chair and the basin in a single horizontal orientation.

4. The pedicure spa of claim 3, wherein the linear actuator comprises a piston-cylinder assembly.

5. The pedicure spa of claim 3 further comprising a carriage linearly translatable along the support and supporting the chair to linearly translate the chair relative to the basin while the chair is in the raised position and while the chair and the basin are in the single horizontal orientation.

6. The pedicure spa of claim 3 further comprising a sensor to sense an obstruction below the support, wherein lowering of the support by the linear actuator is automatically interrupted in response to a sensed obstruction below the support.

7. The pedicure spa of claim 6, wherein the sensor comprises a sensor switch that automatically breaks an electrical circuit connected to the linear actuator.

8. The pedicure spa of claim 6, wherein the sensor comprises a controller that automatically interrupts lowering of the support by the linear actuator in response to signals from the sensor indicating an obstruction below the support.

9. The pedicure spa of claim 6, wherein the sensor comprises:
a panel underlying the basin; and
at least one post projecting upwards from the base towards the support while underlying and supporting the panel, wherein the at least one post moves between an extended position and a retracted position, wherein the at least one post is resiliently biased to the extended position and wherein the at least one post moves towards the retracted position in response to a downward force upon the panel, wherein lowering of the support by the linear actuator is automatically interrupted in response to the at least one post in the retracted position.

10. The pedicure spa of claim 2 further comprising a carriage linearly translatable along the support and supporting the chair to linearly translate the chair relative to the basin while the chair is in the raised position and while the chair and the basin are in the single horizontal orientation.

11. The pedicure spa of claim 2 further comprising a sensor to sense an obstruction below the support, wherein lowering of the support by the linear actuator is automatically interrupted in response to a sensed obstruction below the support.

12. The pedicure spa of claim 11, wherein the sensor comprises a sensor switch that automatically breaks an electrical circuit connected to the linear actuator.

13. The pedicure spa of claim 11, wherein the sensor comprises a controller that automatically interrupts lowering of the support by the linear actuator in response to signals from the sensor indicating an obstruction below the support.

14. The pedicure spa of claim 11 further comprising a panel underlying the basin, wherein the sensor comprises:
at least one post projecting upwards from the base towards the support while underlying and supporting the panel, wherein the at least one post moves between an extended position and a retracted position, wherein the at least one post is resiliently biased to the extended position and wherein the at least one post moves towards the retracted position in response to a downward force upon the panel, wherein lowering of the support by the linear actuator is automatically interrupted in response to the at least one post in the retracted position.

15. The pedicure spa of claim 14, wherein the panel is hooked below the base to limit upward movement of the panel.

16. The pedicure spa of claim 14, wherein the panel is wider than the support.

17. The pedicure spa of claim 11 further comprising a carriage linearly translatable along the support and supporting the chair to linearly translate the chair relative to the basin while the chair is in the raised position and while the chair and the basin are maintained in the single horizontal orientation.

18. A pedicure spa comprising:
a base;
a chair;
a basin;
a support supporting the chair and the basin;
a lift mechanism to vertically move the support, the chair and the basin with the support cantilevered above the base to form a gap of at least 3 inches between the base and the support; and
a sensor to output signals indicating an obstruction within the gap, wherein the signals cause lowering of the support, the chair in the basin by the lift mechanism to be automatically interrupted.

19. The pedicure spa of claim 18 further comprising a panel coupled to the base below the gap, wherein the sensor outputs signals in response to downward movement of the panel towards the base.

20. A method comprising:
concurrently moving a chair and a basin between a raised position and a lowered position while the chair and the basin remain in a single horizontal orientation; and
linearly translating the chair between a forward position and a rearward position relative to the basin while the chair and the basin or in the raised position and while the chair remains in the single horizontal orientation.
